(19) United States
(12) Patent Application Publication
(10) Pub. No.: US 2021/0261750 A1
(43) Pub. Date: Aug. 26, 2021

(54) USE OF BORON NITRIDE NANOSHEETS TO INCREASE COMPOSITE MODULUS AND DECREASE VISCOSITY AND PHASE SEPARATION IN COMPOSITES WITH HYDROPHOBIC MONOMERS

(71) Applicant: The Board of Regents of the University of Texas System, Austin, TX (US)

(72) Inventors: Kyumin Whang, Helotes, TX (US); Alexander Tribley, San Antonio, TX (US); Benjamin R. Furman, San Antonio, TX (US)

(21) Appl. No.: 17/255,342

(22) PCT Filed: Apr. 27, 2019
(86) PCT No.: PCT/US2019/029541

§ 371 Date: Dec. 22, 2020

Related U.S. Application Data
(60) Provisional application No. 62/690,932, filed on Jun. 27, 2018.

(51) Int. Cl. C08K 3/38; C08K 3/40; C08L 63/04; C08J 3/00; C08J 3/28; C08K 5/101; C08K 5/08; C08L 33/16; C08L 35/02

(52) U.S. Cl. CPC C08K 3/38; C08J 2335/02; C08L 63/04; C08J 3/005; C08J 3/28; C08K 5/101; C08K 5/08; C08L 33/16; C08L 35/02; C08K 2003/385; C08K 2003/387; C08K 2201/011; C08J 2363/04; C08J 2333/16; C08K 3/40

(57) ABSTRACT

A composite includes a filler comprising boron nitride nanosheets (BNN) and a resin. The resin includes a multifunctional oxirane epoxy phenol novolac resin (EP8370), a multifunctional acrylate dipenta erythritol hexaacrylate (DPHA), 2-(perfluorooctyl)ethyl acrylate (PFOEA), urethane dimethacrylate (UDMA), and tetryhydrofuran (THF). Additional resins for use with the composite include bisphenol A glycidyl dimethacrylate (BisGMA), urethane dimethacrylate (UDMA), and/or triethylene glycol dimethacrylate (TEGDMA) in any combination thereof.

### CROSS-REFERENCE TO RELATED APPLICATIONS

This patent application claims priority from, and incorporates by reference the entire disclosure of, U.S. Provisional Patent Application No. 62/690,932 filed on Jun. 27, 2018.

### STATEMENT REGARDING FEDERALLY SPONSORED RESEARCH OR DEVELOPMENT

This invention was made with government support under Contract No. U01 DE023778 awarded by the National Institute of Dental and Craniofacial Research. The government has certain rights in the invention

### BACKGROUND

An Oxirane/Acrylate interpenetrating polymer network resin System (OASys) can be used to combat dental composite degradation, reduce polymerization shrinkage stress, and increase composite clinical longevity. The OASys system includes a highly fluorinated acrylate that increases a contact angle (hydrophobicity) to greater than 90°, which results in a reduction of wear in caustic situations, such as with NaOH. The OASys system includes a composite that is opaque, has a high viscosity, and has low mechanical properties most probably resulting from phase separation of the hydrophobic fluorinated acrylates.

### SUMMARY

An illustrative composite includes a filler comprising boron nitride nanosheets (BNN) and a resin. The resin includes a multifunctional oxirane epoxy phenol novolac resin (EP8370), a multifunctional acrylate dipenta erythritol hexaacrylate (DPHA), 2-(perfluorooctyl)ethyl acrylate (PFOEA), urethane dimethacrylate (UDMA), and tetryhydrofuran (THF).

In some embodiments of the illustrative composite, the boron nitride nanosheets comprise approximately 0.5 wt % of the composite. In some embodiments of the illustrative composite, the filler comprises approximately 69.5 wt % of the composite. In some embodiments of the illustrative composite, the resin comprises approximately 30 wt % of the composite. In some embodiments of the illustrative composite, the EP8370 comprises approximately 22.5 wt % of the resin. In some embodiments of the illustrative composite, the DPHA comprises approximately 22.5 wt % of the resin. In some embodiments of the illustrative composite, the PFOEA comprises approximately 17 wt % of the resin. In some embodiments of the illustrative composite, the UDMA comprises approximately 26.875 wt % of the resin. In some embodiments of the illustrative composite, the THF comprises approximately 1.25 wt % of the resin.

In some embodiments of the illustrative composite, the composite includes a photoinitiator system. In some embodiments of the illustrative composite, the photoinitiator system comprises camphorquinone (CQ), borate, and ethyl-4-dimethylamino benzoate (EDMAB). In some embodiments of the illustrative composite, the CQ comprises approximately 0.125 wt % of the resin. In some embodiments of the illustrative composite, the borate comprises approximately 9 wt % of the resin. In some embodiments of the illustrative composite, the EDMAB comprises approximately 0.75 wt % of resin.

In some embodiments of the illustrative composite, the composite comprises a contact angle of greater than 90°. In some embodiments of the illustrative composite, the composite comprises a translucency of greater than 3%. In some embodiments of the illustrative composite, the composite comprises a Young's modulus of approximately 5,456.14 MPa.

An illustrative method of making a composite includes: combining a multifunctional oxirane epoxy phenol novolac resin (EP8370) with born nitride nanosheets (BNNs) in a dimethyl chloride suspension to form a solution; placing the solution in a rotary evaporator to remove the dimethyl chloride suspension; adding tetrahydrofuran (THF), urethane dimethacrylate (UDMA), and a multifunctional acrylate dipenta erythritol hexaacrylate (DPHA) to the solution to form a mixture; mixing the mixture; and adding a photoinitiator system to the mixture, the photoinitiator system including camphorquinone (CQ), borate, and ethyl-4-dimethylamino benzoate (EDMAB); mixing the mixture and the photoinitiator system; adding 2-(perfluorooctyl)ethyl acrylate (PFOEA) to the mixture and the photoinitiator system; and adding a glass filler to the mixture, the photoinitiator system, and PFOEA combination to form the composite.

In some embodiments of the illustrative method, the method incudes placing the composite in a round disk washer, covering the round disk washer with a glass slide on each side of the round disk washer, and curing the composite with a curing light. In some embodiments of the illustrative method, the method forms a composite having a contact angle of greater than 90°.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 is a graph illustrating Rockwall hardness of OASys with 0.5% BNNs and varying concentrations of PFOEA after 24 hours;

FIG. 2 is a graph illustrating contact angle of OASys with 0.5% BNNs with varying concentrations of PFOEA;

FIG. 3 is a graph illustrating translucency of OASys with 0.5% BNNs and varying concentrations of PFOEA after 24 hours;

FIG. 4 is a graph illustrating Young's modulus of OASys with 0.5% BNNs and varying concentrations of PFOEA after 24 hours;

FIG. 5 is a graph illustrating ultimate transverse strength of OASys with 0.5% BNNs and varying concentrations of PFOEA after 24 hours;

FIG. 6 is a graph illustrating energy to break of OASys with 0.5% BNNs and varying concentrations of PFOEA after 24 hours;

FIG. 7 is a graph illustrating volumetric shrinkage of OASys with 0.5% BNNs with varying concentrations of PFOEA; and

FIG. 8 is a graph illustrating shrinkage stress of OASsys with 0.5% BNNs with varying concentrations of PFOEA.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

Boron nitride nanosheets (BNNs) can be added to composites, including OASys composites to provide various benefits. For example, addition of BNN to a composite can reduce a viscosity of the uncured composite blend, increase the transparency of the composite, increase the intrinsic strength and stiffness of the composite, increase an aspect ratio of the composite (source of fracture toughness), and provide high barrier properties. In addition, it has a very low coefficient of friction and may reduce the dental composites wear from the opposing dentition or dental prothesis. However, due to the self-orienting behavior of BNN, it has been suggested that BNN would not be applicable for bulk-curing composites. Initially, a veneering application was considered. However, the widespread use of ceramic veneers negates much of a need for composite veneers.

BNNs have additional beneficial properties, such as: hydrophobicity, an ability to be epoxy or acrylate functionalized, and an ability to self-align. These properties of BNNs are useful in addressing some drawbacks of OASys composites mentioned above as well as other composites, such as but not limited to bisphenol A Glycidyl Dimethacrylate (BisGMA)-based composites or Urethane Dimethacrylate (UDMA)-based composite that may contain a hydrophobic monomer that creates phase separations. For example, the hydrophobicity of BNN's results in better compatibility with hydrophobic fluorinated acrylates, even if it is epoxy-functionalized, and disrupts phase separation. Additionally, epoxy-functionalized BNNs are also chemically compatible with oxirane monomers in the composite and will react with oxirane monomers, further disrupting phase separation. This reduces opacity of the composite and improves mechanical properties. The hydrophobicity of the BNNs also allows less fluorinated acrylates to be used to further reduce opacity and phase separation. In addition, the self-aligning nature of BNNs reduces viscosity and allows higher filler loading, which further improves mechanical properties of the composite. Adding BNN to OASys composites has shown these improvements to occur. Additional discussion of OASys composites for use with the instant disclosure can be found in U.S. patent application Ser. No. 15/302,320, which is incorporated herein by reference in its entirety.

In various embodiments, the composite can include various resins. Resins that can be used with various embodiments of the present disclosure include, without limitation: Bis-GMA (bisphenol glycidyl methacrylate) based resins; poly (methyl methacrylate) (PMMA) based resins; TEGDMA (triethylene glycol dimethacrylate) based resins; HEMA (2-hydroxyethyl methacrylate) based resins; PMDM (pyromellitic acid diethylmethacrylate) based resins; PMGDM (pyromellitic acid glycerol dimethacrylate) based resins; UDMA (urethane dimethacrylate) based resins; methacrylate based resins; dimethacrylate based resins; hydrophobic resins; hydrophilic resins; and hardenable monomers suitable for dental and orthopedic applications. The resins disclosed herein can be used alone or in any combination. In some embodiments, the resin includes fluorinated acrylates, fluorinated methacrylates, and fluorinated epoxides. Additional discussion of resins can be found in U.S. Pat. No. 10,154,669 and U.S. patent application Ser. No. 15/302,320, each of which is incorporated herein by reference in its entirety.

In various embodiments, the composite includes a photoinitiator system. An illustrative photoinitiator systems includes camphorquinone (CQ, Esstech), 4-Isopropyl-4′-methyldiphenyliodonium tetrakis (pentafluorophenyl) borate (Borate, Tokyo Chemical Industry, Tokyo, Japan), and ethyl-4-dimethylamino benzoate (EDMAB, Esstech). Additional photoinitiator systems can include onium-ion or other cationic photoinitiators. In some embodiments the photoinitiator system comprises at least one of 2,3-butanedione, 2,3-pentanedione, 2,3-hexanedione, 3,4-hexanedione, 2,3-heptanedione, 3,4-heptanedione, 2,3-octanedione, 4,5-octanedione, benzil, 2,2′-3 3′- and 4,4′-dihydroxylbenzil, furil, di-3,3′-indolylethanedione, 2,3-bornanedione (camphorquinone), biacetyl, 1,2-cyclohexanedione, 1,2-naphthaquinone, or acenaphthaquinone. U.S. Pat. No. 9,125,817, which is incorporated herein by reference in its entirety, provides additional discussion of photointiator systems and monomers for use with the instant disclosure.

In some embodiments, the composite includes a cationic polymerizer selected from: p-octyloxy phenyl-phenyl iodonium hexafuoantimonate (OPPI), tris(methylphenyl) sulfonium hexafluoroantimonate, diphenyliodonium tetrafluoroborate; di(4-methylphenyl)iodonium tetrafluoroborate; phenyl-4-methylphenyliodonium tetrafluoroborate; di(4-heptylphenyl)iodonium tetrafluoroborate; di(3-nitrophenyl)iodonium hexafluorophosphate; di(4-chlorophenyl)iodonium hexafluorophosphate; di(naphthyl)iodonium tetrafluoroborate; di(4-trifluoromethylphenyl)iodonium tetrafluoroborate; diphenyliodonium hexafluorophosphate; di(4-methylphenyl)iodonium hexafluorophosphate; diphenyliodonium hexafluoroarsenate; di(4-phenoxyphenyl)iodonium tetrafluoroborate; phenyl-2-thienyliodonium hexafluorophosphate; 3,5-dimethylpyrazolyl-4-phenyliodonium hexafluorophosphate; diphenyliodonium hexafluoroantimonate; 2,2′-diphenyliodonium tetrafluoroborate; di(2,4-dichlorophenyl)iodonium hexafluorophosphate; di(4-bromophenyl)iodonium hexafluorophosphate; di(4-methoxyphenyl)iodonium hexafluorophosphate; di(3-carboxyphenyl)iodonium hexafluorophosphate; di(3-methoxycarbonylphenyl)iodonium hexafluorophosphate; di(3-methoxysulfonylphenyl)iodonium hexafluorophosphate; di(4-acetamidophenyl)iodonium hexafluorophosphate; di(2-benzothienyl)iodonium hexafluorophosphate; diphenyliodonium hexafluoroantimonate (DPISbF6); diaryliodoniun hexafluorophosphate; diaryliodonium hexafluoroantimonate; diphenyliodonium hexafluoroantimonate (DP), [4(1-octadecylphenoxyacetate)]phenyl iodonium hexafluoroantimonate (OPPA); and, (4-octadecyloxyphenyl)phenyl iodonium hexafluoro hexafluoroantimonate (OPP), and the like.

### Working Examples

An illustrative formulation of OASys composite designated as 4O6ASys-F is as follows: a multifunctional oxirane epoxy phenol novolac resin (Epalloy (EP)8370, 3.9 functionality, CVC Thermoset Specialties, Moorestown, N.J.), a multifunctional acrylate dipenta erythritol hexaacrylate (DPHA, 6 functionality, Sigma-Aldrich), urethane dimethacrylate (UDMA, Esstech, Essington, Pa.), 2-(perfluorooctyl)ethyl acrylate (PFOEA, Oakwood Chemical, Estill, S.C.), and tetryhydrofuran (THF250, Sigma Aldrich). These blends were filled with 70% w/w acrylate-silanated glass filler. A photoinitiator system for these monomer blends contained camphorquinone (CQ, Esstech), 4-Isopropyl-4′-methyldiphenyliodonium tetrakis (pentafluorophenyl) borate (Borate, Tokyo Chemical Industry, Tokyo, Japan), and ethyl-4-dimethylamino benzoate (EDMAB, Esstech).

An illustrative formulation for 4O6ASys-F with BNN is as follows: 69.5 wt % acrylate-silanated glass filler+0.5 wt % BNN. Resin 30% by total weight containing 22.5 wt % EP8370, 22.5 wt % DPHA, 17% wt % PFOEA (This is changed depending on the sample test), 26.875% wt % UDMA, 1.25 wt % THF, 0.125 wt % CQ, 9 wt % Borate, 0.75 wt % EDMAB.

A procedure for specimen preparation is as follows: EP8370 is added to BNNs (in dimethyl chloride suspension) and placed in a rotary evaporator to remove the dimethyl chloride. Then THF, UDMA and DPHA are added to the mixture. This mixture is then mixed in a FlackTek SpeedMixer™ DAC 150 (FlackTek, Inc., Landrum, S.C.) and a photoinitiator system of CQ, Borate, and EDMAB is added and mixed again. Before the main glass filler is added, the PFOEA is added and mixed. The last material to be added is the glass filler which is first mixed in the SpeedMixer™, then manipulated by hand until a desired blend is achieved. The composite is then placed in a round disk washer and covered with a glass slide on each side. The composite is then light cured using a VALO® broadband LED curing light for 20 seconds on both sides of the round disk washer in a ⅜″ d× 1/16″ thick mold.

The PFOEA concentration in the monomer blend was varied from 30 wt % to 15 wt % and replaced with UDMA. The composite was tested for degree of cure (Rockwell_{15T} hardness), hydrophobicity (contact angle measurement), translucency, mechanical properties (three-point bend test), polymerization shrinkage (Acuvol II), and shrinkage stress (BISCO Polymerization Stress Tester).

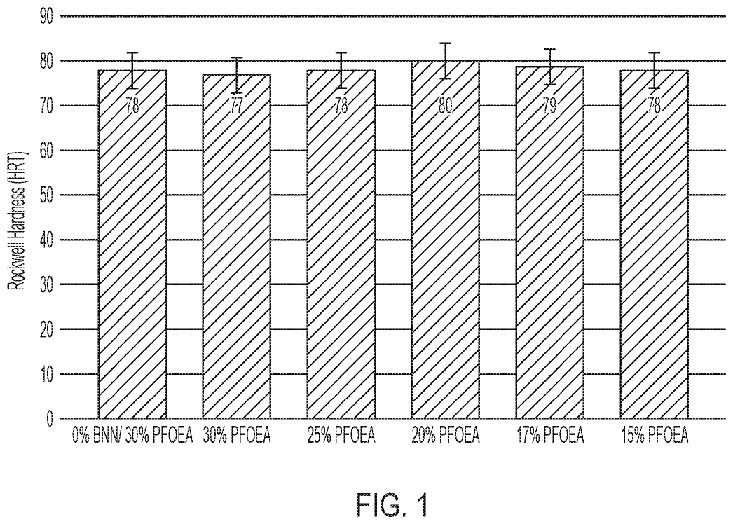

FIG. 1 is a graph illustrating Rockwall_{15T} hardness of OASys with 0.5% BNNs and varying concentrations of PFOEA after 24 hours. The additions of BNNs did not have a significant impact on the hardness at 70% filler loading, indicating that all of the tested formulations cured well. FIG. 1 includes data for the following concentrations: 0% BNN with 30% PFOEA; 0.5% BNN with 30% PFOEA; 0.5% BNN with 25% PFOEA; 0.5% BNN with 20% PFOEA; 0.5% BNN with 17% PFOEA; and 0.5% BNN with 15% PFOEA. As illustrated in FIG. 1, the various concentrations test showed no significant impart in Rockwall_{15T} hardness, ranging from 77-79 HRT for all concentrations tested.

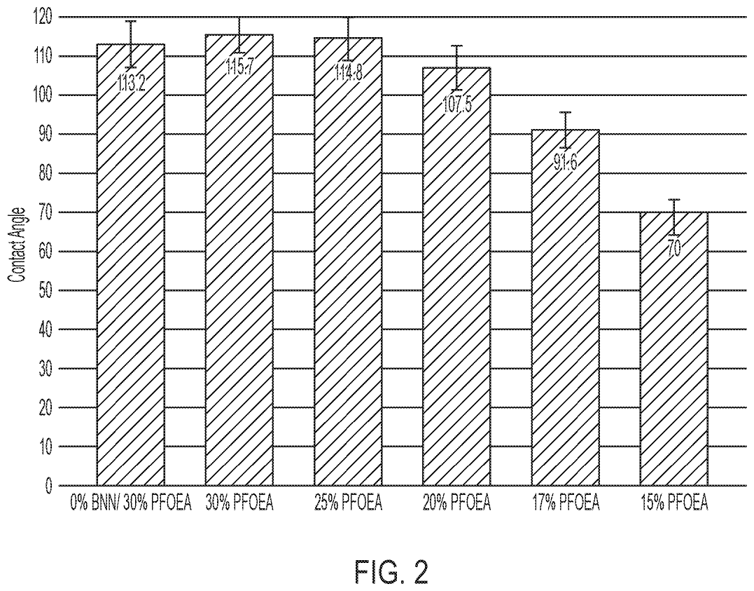

FIG. 2 is a graph illustrating contact angle of OASys composites with 0.5% BNNs with varying concentrations of PFOEA. FIG. 2 includes data for the following concentrations: 0% BNN with 30% PFOEA; 0.5% BNN with 30% PFOEA; 0.5% BNN with 25% PFOEA; 0.5% BNN with 20% PFOEA; 0.5% BNN with 17% PFOEA; and 0.5% BNN with 15% PFOEA. FIG. 2 illustrates that the addition of BNNs to the OASys composite kept the composite hydrophobic (i.e., contact angle >90°) with lower amounts of PFOEA, which has not been done before, as previous trials at 25% PFOEA have yielded contact angles of 70°. As demonstrated in FIG. 2, 0.5% BNN with 25% PFOEA resulted in a contact angle of about 114.8°. Lowering the PFOEA concentration to 17% still resulted in a contact angle of about 91.6°.

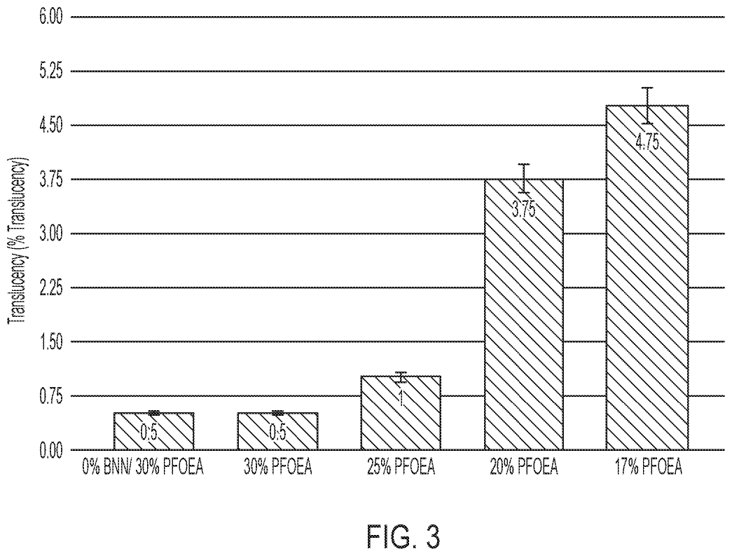

FIG. 3 is a graph illustrating translucency of OASys with 0.5% BNNs and varying concentrations of PFOEA after 24 hours. Previously, a reduction of PFOEA concentration did not reduce opacity. However, addition of the BNNs disrupted the phase separation causing a significant decrease in opacity with the decrease in PFOEA. FIG. 3 includes data for the following concentrations: 0% BNN with 30% PFOEA; 0.5% BNN with 30% PFOEA; 0.5% BNN with 25% PFOEA; 0.5% BNN with 20% PFOEA; and 0.5% BNN with 17% PFOEA. The decrease in opacity improves the composite's commercial viability. In addition, a significant reduction in viscosity of the composition was noticed. The lower viscosity allows for greater filler loading and therefore improved mechanical properties.

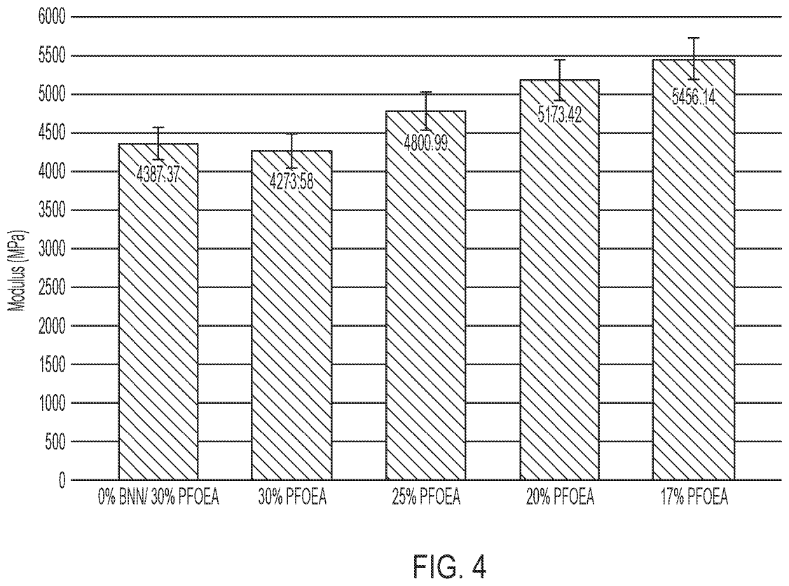

FIG. 4 is a graph illustrating Young's modulus of OASys composites with 0.5% BNNs and varying concentrations of PFOEA after 24 hours. FIG. 4 includes data for the following concentrations: 0% BNN with 30% PFOEA; 0.5% BNN with 30% PFOEA; 0.5% BNN with 25% PFOEA; 0.5% BNN with 20% PFOEA; and 0.5% BNN with 17% PFOEA. The addition of BNNs and the consequent decrease in PFOEA concentration significantly increased Young's modulus of elasticity.

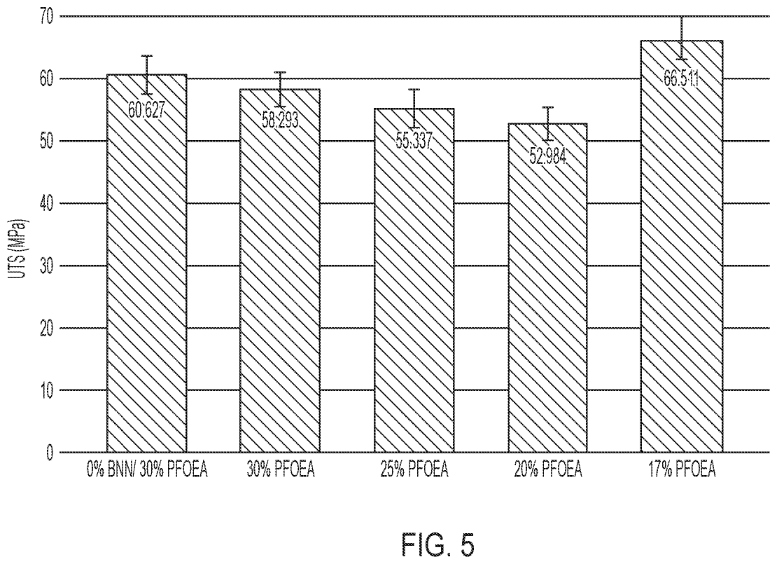

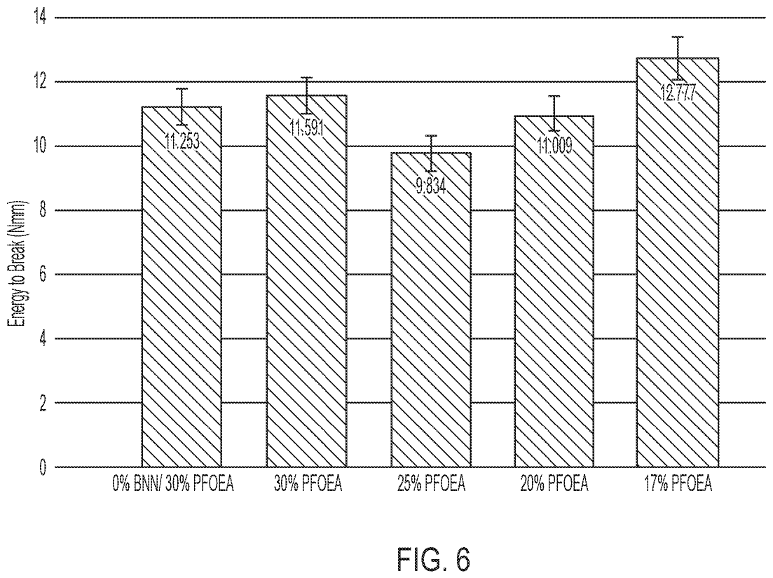

FIG. 5 is a graph illustrating ultimate transverse strength of OASys composites with 0.5% BNNs and varying concentrations of PFOEA after 24 hours and FIG. 6 is a graph illustrating energy to break of OASys with 0.5% BNNs and varying concentrations of PFOEA after 24 hours. FIGS. 5 and 6 include data for the following concentrations: 0% BNN with 30% PFOEA; 0.5% BNN with 30% PFOEA; 0.5% BNN with 25% PFOEA; 0.5% BNN with 20% PFOEA; and 0.5% BNN with 17% PFOEA. The addition of BNNs also gave varying results for ultimate transverse strength and energy to break (e.g., see FIGS. 5 and 6, respectively). At 17 wt. % PFOEA, there were significant increases in both ultimate tensile strength and energy to break. This is further evidence that the BNNs have disrupted the phase separation.

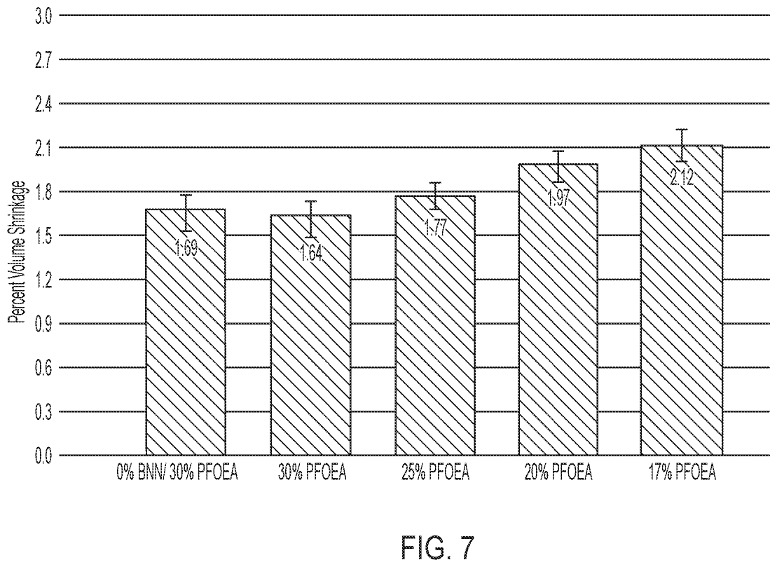

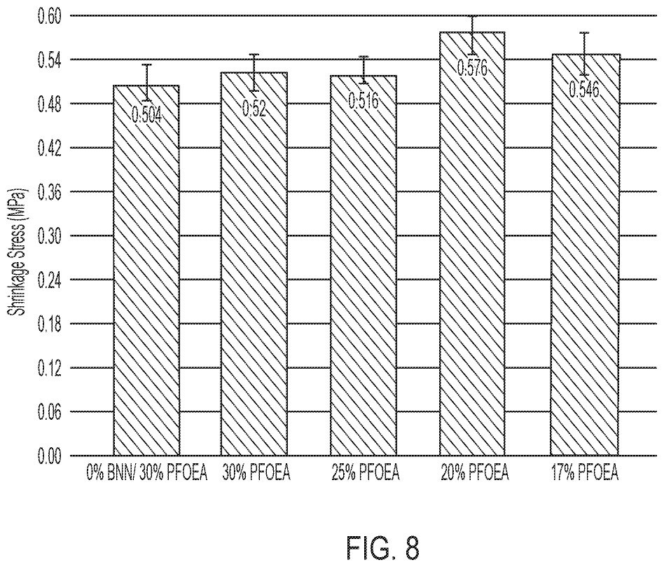

FIG. 7 is a graph illustrating volumetric shrinkage of OASys composites with 0.5% BNNs with varying concentrations of PFOEA and FIG. 8 is a graph illustrating shrinkage stress of OASsys composites with 0.5% BNNs with varying concentrations of PFOEA. FIGS. 7 and 8 include data for the following concentrations: 0% BNN with 30% PFOEA; 0.5% BNN with 30% PFOEA; 0.5% BNN with 25% PFOEA; 0.5% BNN with 20% PFOEA; and 0.5% BNN with 17% PFOEA. Volumetric shrinkage (e.g., see FIG. 7) and shrinkage stress (e.g., see FIG. 8) were shown to be not significantly affected by the addition of BNNs to the composite. The increase of volumetric shrinkage, although low, could be a result of better curing and subsequent polymerization due to the lower amounts of PFOEA that can be achieved with BNNs.

### Advantages

An advantage of the composites discussed herein is that they can be used to make hydrophobic monomers more compatible in more hydrophilic resins and disrupt phase separation. The new composites have reduced viscosity, allowing increased filler loading for increased mechanical properties. BNNs can be incorporated into different OASys composites or in bisphenol A Glycidyl Dimethacrylate (BisGMA)-based composites or in Urethane Dimethacrylate (UDMA)-based composites widely used in current commercial dental composites to improve filler loading. The new composites also exhibit reduced resin degradation. BNNs can be incorporated into different OASys composites or in BisGMA-based composites or in UDMA-based composites to reduce composite wear rate. The new composites allow less hydrophobic monomers to be used to achieve comparable hydrophobicity.

### Commercial Applications

Composites utilizing aspects of the invention have various commercial applications, including various commercial composites that need to be hydrophobic. As an example, the inventive composites can be used with OASys composites to solve issues of opacity and viscosity, yielding improved mechanical properties. Such composites can be used in dental applications to provide durable and natural looking dental work.

Composites utilizing aspects of the invention have various commercial applications, including various commercial composites that need to have reduced wear rates, reduced viscosity, or increased filler loading. As an example, the inventive composites can be used with BisGMA-based and/or UDMA-based composites to reduce viscosity, yielding increased flowability and/or increased filler loading. This would result in increased mechanical properties, including reduced composite wear rate. In addition, the BNNs, by means of its low coefficient of friction when aligned, would yield reduced composite wear rate. Such composites can be used in dental applications to provide durable and natural looking dental work.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “generally,” and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

1. A composite comprising:
a filler comprising boron nitride nanosheets (BNN); and
a resin comprising:
a multifunctional oxirane epoxy phenol novolac resin (EP8370);
a multifunctional acrylate dipenta erythritol hexaacrylate (DPHA);
2-(perfluorooctyl)ethyl acrylate (PFOEA);
urethane dimethacrylate (UDMA); and
tetryhydrofuran (THF).

2. The composite of claim 1, wherein the boron nitride nanosheets comprise approximately 0.5 wt % of the composite.

3. The composite of claim 1, wherein the filler comprises approximately 69.5 wt % of the composite.

4. The composite of claim 1, wherein the resin comprises approximately 30 wt % of the composite.

5. The composite of claim 4, wherein the EP8370 comprises approximately 22.5 wt % of the resin.

6. The composite of claim 4, wherein the DPHA comprises approximately 22.5 wt % of the resin.

7. The composite of claim 4, wherein the PFOEA comprises approximately 17 wt % of the resin.

8. The composite of claim 4, wherein the UDMA comprises approximately 26.875 wt % of the resin.

9. The composite of claim 4, wherein the THF comprises approximately 1.25 wt % of the resin.

10. The composite of claim 1, further comprising a photoinitiator system.

11. The composite of claim 10, wherein the photoinitiator system comprises camphorquinone (CQ), borate, and ethyl-4-dimethylamino benzoate (EDMAB).

12. The composite of claim 11, wherein the CQ comprises approximately 0.125 wt % of the resin.

13. The composite of claim 11, wherein the borate comprises approximately 9 wt % of the resin.

14. The composite of claim 11, wherein the EDMAB comprises approximately 0.75 wt % of resin.

15. The composite of claim 10, wherein the photoinitiator system comprises at least one of 2,3-butanedione, 2,3-pentanedione, 2,3-hexanedione, 3,4-hexanedione, 2,3-heptanedione, 3,4-heptanedione, 2,3-octanedione, 4,5-octanedione, benzil, 2,2′-3 3′- and 4,4′-dihydroxylbenzil, furil, di-3,3′-indolylethanedione, 2,3-bornanedione (camphorquinone), biacetyl, 1,2-cyclohexanedione, 1,2-naphthaquinone, or acenaphthaquinone.

16. The composite of claim 1, wherein the composite comprises a contact angle of greater than 90°.

17. The composite of claim 1, wherein the resin comprises fluorinated acrylates, fluorinated methacrylates, and fluorinated epoxides.

18. A composite comprising:
a filler comprising boron nitride nanosheets (BNN); and
a resin selected from the group consisting of bisphenol glycidyl methacrylate (Bis-GMA), poly (methyl methacrylate) (PMMA), triethylene glycol dimethacrylate (TEGDMA), 2-hydroxyethyl methacrylate (HEMA), pryomellitic acid diethylmethacrylate (PMDM), pyromellitic acid glycerol dimethacrylate (PMGDM), and urethane dimethacrylate (UDMA).

19. A method of making a composite, the method comprising:
combining a multifunctional oxirane epoxy phenol novolac resin (EP8370) with born nitride nanosheets (BNNs) in a dimethyl chloride suspension to form a solution;
placing the solution in a rotary evaporator to remove the dimethyl chloride suspension;
adding tetryhydrofuran (THF), urethane dimethacrylate (UDMA), and a multifunctional acrylate dipenta erythritol hexaacrylate (DPHA) to the solution to form a mixture;
mixing the mixture; and
adding a photoinitiator system to the mixture, the photoinitiator system comprising camphorquinone (CQ), borate, and ethyl-4-dimethylamino benzoate (EDMAB);
mixing the mixture and the photoinitiator system;
adding 2-(perfluorooctyl)ethyl acrylate (PFOEA) to the mixture and the photoinitiator system; and
adding a glass filler to the mixture, the photoinitiator system, and PFOEA combination to form the composite.

20. The method of claim 19, further comprising:
placing the composite in a round disk washer and covering the round disk washer with a glass slide on each side of the round disk washer; and
curing the composite with a curing light.
